(19) United States
(12) Patent Application Publication
(10) Pub. No.: US 2026/0201261 A1
(43) Pub. Date: Jul. 16, 2026

(54) SYSTEMS AND METHODS FOR CHEMICAL LOOPING PYROLYSIS OF CARBONACEOUS SOLID FUELS

(71) Applicant: Ohio State Innovation Foundation, Columbus, OH (US)

(72) Inventors: Liang-Shih Fan, Columbus, OH (US); Danwyn J. Aranha, Columbus, OH (US)

(21) Appl. No.: 19/445,306

(22) Filed: Jan. 9, 2026

Related U.S. Application Data
(60) Provisional application No. 63/744,078, filed on Jan. 10, 2025.

(51) Int. Cl. C10J 3/66; B01J 6/00; B01J 8/18; B01J 8/26; C10B 49/18; C10B 57/14; C10G 1/02; C10J 3/48; C10J 3/62

(52) U.S. Cl. CPC C10J 3/66; B01J 6/008; B01J 8/1827; B01J 8/1836; B01J 8/26; C10B 49/18; C10B 57/14; C10G 1/02; C10J 3/482; C10J 3/62; B01J 2208/0038; B01J 2208/00504; C10G 2300/1003; C10G 2300/1011; C10J 2300/0916; C10J 2300/093; C10J 2300/0946; C10J 2300/1625; C10J 2300/1807

(57) ABSTRACT

Exemplary systems and methods include a moving bed reducer reactor and a fluidized bed combustor reactor. Exemplary reducer reactors may be divided into two regions. An upper portion comprises a pyrolysis region, and a lower portion comprises a gasification region. Solid fuel enters the reactor in the pyrolysis region, leading to the pyrolysis of the solid fuel, which forms volatiles and char. The char moves into the gasification region, filled with regenerated oxygen carrier particles. The volatiles move up into the top section of the reactor, are collected at an outlet, and condensed. Condensation of the volatiles leads to the formation of bio-oil. The char comes in contact with oxygen carrier particles, leading to char gasification.

### CROSS-REFERENCE TO RELATED APPLICATIONS

This application claims priority to U.S. Provisional Patent Application No. 63/744,078, filed on Jan. 10, 2025, the entire contents of which is incorporated herein by reference.

### TECHNICAL FIELD

The present disclosure generally relates to chemical looping moving bed pyrolysis. Exemplary systems and methods are particularly suited for processing solid fuels.

### INTRODUCTION

Chemical looping technology is one of the most promising technologies for fighting climate change with minimal environmental effects. Chemical looping technology comprises a reducer section, a regenerator section, and oxygen carrier particles, which donate lattice oxygen to the fuel. Oxygen carrier particles react with carbonaceous fuels, are reduced to a lower oxidation state, and generate essential chemicals such as syngas (carbon monoxide (CO) and hydrogen (H₂)). Additionally, oxygen carrier particles react with air or steam (H₂O) to be regenerated by replenishing their lattice oxygen.

Pyrolysis of carbonaceous material in an inert atmosphere produces carbonaceous volatiles (gases or liquid aerosols) in the reactor at high temperatures, which yields bio-oil, a value-added product with characteristics similar to crude oil obtained from fossil reserves. Char is also produced as a solid residue that can be used for various applications such as carbon capture, soil amendment, and syngas production.

Chemical looping pyrolysis is challenging because any contact between oxygen carrier particles and the formed carbonaceous volatiles in the reactor can crack the carbonaceous volatiles into gaseous products like carbon dioxide (CO₂), methane (CH₄), and hydrogen (H₂), thereby lowering bio-oil yield. Further, using fluidized beds as reducers for chemical looping technology has also hindered the pyrolysis of solid fuels because fluidized beds lead to the complete mixing of oxygen carrier particles and the solid fuel, thereby rendering the pyrolysis process not feasible.

### SUMMARY

In some aspects, the techniques described herein relate to a method for operating a reactor system including a reducer reactor and a combustor reactor, the method including: providing a fuel stream to a pyrolyzing region of the reducer reactor, the fuel stream including solid carbonaceous fuel; wherein the gasifying region is in a lower portion of the reducer reactor and the pyrolyzing region is in an upper portion of the reducer reactor; providing a barrier stream adjacent to an interface of the pyrolyzing region and the gasifying region of the reducer reactor, the barrier stream including an inert gas; providing oxygen carrier particles to the gasifying region of the reducer reactor; providing a steam (H₂O) stream to the gasifying region of the reducer reactor, such that the steam (H₂O) stream contacts the oxygen carrier particles, oxidizing carbonaceous material on the oxygen carrier particles and oxidizing the oxygen carrier particles; collecting a pyrolyzing region output stream generated in the reducer reactor from a pyrolyzing region outlet, the pyrolyzing region output stream including carbonaceous volatiles; collecting a gasifying region output stream generated in the reducer reactor from a gasifying region outlet, the gasifying region output stream including carbon monoxide (CO) and hydrogen (H₂); providing partially reduced oxygen carrier particles to the combustor reactor; providing an oxidation stream to the combustor reactor such that the oxidation stream contacts the oxygen carrier particles, oxidizing the oxygen carrier particles, and fluidizing the oxygen carrier particles, the oxidation stream including air; collecting a combustor reactor output stream from a combustor reactor outlet, the combustor reactor output stream including oxygen-depleted air; and providing the oxidized oxygen carrier particles from the combustor reactor to the reducer reactor.

In some aspects, the techniques described herein relate to a reactor system, including: a moving bed reducer reactor including: a pyrolyzing region in an upper portion of the moving bed reducer reactor; a gasifying region in a lower portion of the moving bed reducer reactor, the gasifying region occupying between 40 volume percent (vol %) and 60 vol % of an inner volume of the moving bed reducer reactor and including: oxygen carrier particles or inert particles, a steam (H₂O) stream input, a particle outlet configured to provide a particle output stream; and a barrier stream input adjacent to an interfacial region of the pyrolyzing region and the gasifying region, the barrier stream input in fluid communication with an inert gas source; a solid carbonaceous fuel stream inlet positioned in the pyrolyzing region and configured to receive a solid carbonaceous fuel from a solid carbonaceous fuel stream input source; a barrier stream inlet configured to receive the barrier stream input from a barrier stream input source; a steam (H₂O) inlet configured to receive steam (H₂O) from a steam (H₂O) stream input source; a particle inlet positioned in the gasifying region and configured to receive oxygen carrier particles or inert particles from an oxygen carrier particle or inert particle input source; a pyrolyzing region outlet configured to provide a pyrolyzing region output stream including carbonaceous volatiles; and a fluidized bed combustor reactor including: oxygen carrier particles or inert particles; a combustor oxidation stream inlet in fluid communication with a combustor oxidation stream input source configured to receive a combustor oxidation stream input; and a combustor reactor outlet configured to provide a combustor reactor output stream.

In some aspects, the techniques described herein relate to a method for operating a reactor system including a reducer reactor and a combustor reactor, the method including: providing a fuel stream to a pyrolyzing region of the reducer reactor, the fuel stream including solid carbonaceous fuel, wherein the gasifying region is in a lower portion of the reducer reactor and the pyrolyzing region is in an upper portion of the reducer reactor; providing a barrier stream adjacent to an interface of the pyrolyzing region and the gasifying region of the reducer reactor, the barrier stream including an inert gas; providing inert particles to the gasifying region of the reducer reactor; providing a steam (H₂O) stream to the gasifying region of the reducer reactor, such that the steam (H₂O) stream contacts the carbonaceous material on the inert particles and the carbonaceous material is oxidized; collecting a pyrolyzing region output stream generated in the reducer reactor from a pyrolyzing region outlet, the pyrolyzing region output stream including carbonaceous volatiles; providing the pyrolyzing region output stream to a condenser; providing inert particles to the combustor reactor; providing an oxidation stream to the combustor reactor, such that the oxidation stream contacts carbonaceous material on the inert particles and the carbonaceous material is oxidized, and fluidizing the inert particles; collecting a combustor reactor output stream from a combustor reactor outlet; and providing the inert particles from the combustor reactor to the reducer reactor, wherein heat generated in a combustor reactor provides heat to the pyrolyzing region via the inert particles.

### BRIEF DESCRIPTION OF THE DRAWINGS

FIG. 1 is a schematic diagram of an exemplary reactor system.

FIG. 2 is a schematic diagram of an exemplary embodiment of a reactor system.

FIG. 3 is a schematic diagram of another exemplary embodiment of a reactor system.

FIG. 4 is a schematic diagram of another exemplary embodiment of a reactor system.

FIG. 5 is a schematic diagram of another exemplary embodiment of a reactor system.

FIG. 6 is a schematic diagram of another exemplary embodiment of a reactor system.

FIG. 7 is a schematic diagram of another exemplary embodiment of a reactor system.

FIG. 8 is a schematic diagram of another exemplary embodiment of a reactor system.

FIG. 9 is a bar graph showing product yield for three different moving bed reducer reactor temperatures of 400° C., 500° C., and 600° C.

FIG. 10 is a plot showing gas concentration as a function of time, with a moving bed reducer reactor temperature of 400° C.

FIG. 11 is a plot showing gas concentration as a function of time, with a moving bed reducer reactor temperature of 500° C.

FIG. 12 is a plot showing gas concentration as a function of time, with a moving bed reducer reactor temperature of 600° C.

FIG. 13 is a ¹H NMR spectrum of exemplary bio-oil produced with a moving bed reducer reactor temperature of 500° C.

FIG. 14 is a plot showing syngas purity as a function of time, with a moving bed reducer reactor temperature of 500° C.

### DETAILED DESCRIPTION

The present disclosure relates to systems and methods for processing solid carbonaceous fuel. Broadly, exemplary systems and methods include a moving bed reducer reactor and a fluidized bed combustor reactor. Exemplary reducer reactors are divided into two regions. An upper portion comprises a pyrolysis region, and a lower portion comprises a gasification region. Solid fuel enters the reactor in the pyrolysis region, leading to the pyrolysis of the solid fuel, which forms volatiles and char. The char moves into the gasification region, filled with regenerated oxygen carrier particles. The volatiles move up into the top section of the reactor, are collected at an outlet, and condensed. Condensation of the volatiles leads to the formation of bio-oil. The char comes in contact with oxygen carrier particles, leading to char gasification.

Accordingly, in some instances, exemplary chemical looping moving bed pyrolysis systems may perform in-situ gasification of char. Alternatively, in some instances, char formed from solid fuel pyrolysis can be carried into the fluidized bed regenerator using inert material as a carrier. The solid char is then collected from the fluidized bed through an outlet as fines, which can be used for various applications.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number therebetween with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

A “moving bed reactor” is defined as a reactor where particles flow in a single direction, generally, from top to bottom. The fluid material can flow in the same direction as the particles (co-current movement). The fluid material can flow in an opposite direction as the particles (countercurrent movement).

A “fluidized bed reactor” is defined as a reactor where fluid is passed through particles at a sufficient speed to suspend the solid particles. Typically, particles may move in any direction, bounded by the walls of the reactor.

A “fixed bed reactor” is defined as a reactor where particles are fixed in a packed bed. Fluid is passed through particles, but the fluid does not suspend the particles, as in a fluidized bed reactor.

### II. Exemplary Materials

Exemplary systems, methods, and techniques disclosed and contemplated herein may use and generate various materials. Exemplary materials include particles, input streams, and outputs. Various aspects of each are described below.

### A. Exemplary Particles

In some implementations, exemplary systems and methods utilize oxygen carrier particles. In other implementations, exemplary systems and methods utilize inert particles.

Exemplary oxygen carrier particles may include one or more active metal oxides. In some instances, exemplary metal oxide composites may have at least one of the active metals as iron (Fe). Exemplary metal oxide composites may be a single phase or a mixture of multiple active phases. In various instances, the metal oxide composite comprises more than one active metal capable of undergoing a change in oxidation state under reducing or oxidizing conditions, or a phase change under a partial pressure of carbon dioxide (CO₂).

Exemplary oxygen carrier particles may be characterized by their degree of reduction or oxidation. For example, a higher degree of reduction indicates a more reduced state of oxygen carrier particles. For example, when the oxygen carrier particles comprise Fe₂O₃, the lowest degree of reduction (or highest degree of oxidation) corresponds to a fully oxidized state (Fe₂O₃), while the highest degree of reduction (lowest degree of oxidation) corresponds to a fully reduced state (metallic Fe).

The recyclability of exemplary metal oxide particles may be promoted by adding supportive oxides, also termed support materials, which may also affect the lattice oxygen ion diffusivity. The support material may be any support material known and used in the art. Non-limiting examples of support materials include, but are not limited to, silica (SiO₂), magnesia (MgO), alumina (Al₂O₃), ceria (CeO₂), titania (TiO₂), zirconia (ZrO₂), or a combination comprising two or more of the aforementioned supports, such as magnesium aluminate spinel (MgAl₂O₄).

The amount of support material may be 20 wt % to 80 wt % of the metal oxide particle. In various implementations, exemplary metal oxide particles may comprise 20 wt % to 80 wt %; 25 wt % to 75 wt %; 30 wt % to 70 wt %; 35 wt % to 65 wt %; 40 wt % to 60 wt %; 45 wt % to 55 wt %; 50 wt % to 80 wt %; 20 wt % to 50 wt %; 25 wt % to 50 wt %; or 30 wt % to 50 wt % support material. In some instances, the amount of support material may be no greater than 80 wt %; no greater than 75 wt %; no greater than 70 wt %; no greater than 65 wt %; no greater than 60 wt %; no greater than 55 wt %; or no greater than 50 wt %. In some instances, the amount of support material may be no less than 20 wt %; no less than 25 wt %; no less than 30 wt %; no less than 35 wt %; no less than 40 wt %; or no less than 45 wt %.

Inert carbonate materials, such as potassium carbonate (K₂CO₃), may also be included as a part of the overall composite solid, which may later combine with the carbonate phase to form a mixed metal carbonate.

In some implementations, the reactivity of metal oxide particles may be enhanced by low-concentration dopant modification. One or more dopants may comprise 0 wt % to about 5 wt % of the oxygen carrier particles. In various instances, metal oxide particles may comprise 0 wt % to 5 wt %; 0.5 wt % to 5 wt %; 1 wt % to 5 wt %; 1.5 wt % to 5 wt %; 2 wt % to 5 wt %; 2.5 wt % to 5 wt %; 3 wt % to 5 wt %; 3.5 wt % to 5 wt %; 4 wt % to 5 wt %; 0.5 wt % to 4.5 wt %; 1 wt % to 4 wt %; 1 wt % to 3 wt %; 1 wt % to 2 wt %; 2 wt % to 3 wt %; 2.5 wt % to 3.5 wt %; 3 wt % to 4 wt %; or 4wt % to 4.5 wt % dopant. In some instances, the dopant concentration may be no greater than 5 wt %; no greater than 4.5 wt %; no greater than 4 wt %; no greater than 3.5 wt %; no greater than 3 wt %; or no greater than 2 wt %. In some instances, the dopant concentration may be no less than 0.5 wt %; no less than 1 wt %; no less than 1.5 wt %; no less than 2 wt %; no less than 2.5 wt %; or no less than 3 wt %.

Exemplary dopants may have one or more of the following impacts on reactivity enhancement of cyclic chemical looping redox reactions. Exemplary catalytic dopants may provide extra reaction sites during CO₂ capture and hydrocarbon conversion, in addition to the host transition metal oxide particles, such as iron oxide. The nature of aliovalent dopants, such as Cu²⁺, Co²⁺, Ni²⁺ vs Fe³⁺, may result in an increase of oxygen vacancies, which may promote oxygen ion transport in methane partial oxidation and improve syngas quality. Exemplary catalytic dopants may lower the reaction energy barrier of CO₂ capture and C—H activation with the host transition metal oxide particles.

Example catalytic transition metal dopants include, but are not limited to, nickel (Ni), cobalt (Co), copper (Cu), scandium (Sc), titanium (Ti), vanadium (V), chromium (Cr), manganese (Mn), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lutetium (Lu), hafnium (Hf), tantalum (Ta), tungsten (W), rhenium (Re), osmium (Os), iridium (Ir), platinum (Pt), and gold (Au).

Exemplary oxygen carrier particles may comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof.

Exemplary inert particles are not reactants in either reduction or oxidation reactions. Exemplary inert particles may comprise SiO₂, Al₂O₃, aluminosilicates, kaolin, mullite, alumina-zirconia-silica, CaAl₂O₄, CaAl₄O₇, or combinations thereof.

Exemplary oxygen carrier particles or inert particles may have a D_{V}90 size between 1.00 mm and 2.00 mm; 1.13 mm and 2.00 mm; 1.25 mm and 2.00 mm; 1.38 mm and 2.00 mm; 1.50 mm and 2.00 mm; 1.63 mm and 2.00 mm; 1.75 mm and 2.00 mm; 1.88 mm and 2.00 mm; 1.00 mm and 1.88 mm; 1.00 mm and 1.75 mm; 1.00 mm and 1.63 mm; 1.00 mm and 1.50 mm; 1.00 mm and 1.38 mm; 1.00 mm and 1.25 mm; or 1.00 mm and 1.13 mm. In some implementations, oxygen carrier particles or inert particles may have D_{V}90 sizes no less than 1.00 mm; no less than 1.13 mm; no less than 1.25 mm; no less than 1.38 mm; no less than 1.50 mm; no less than 1.63 mm; no less than 1.75 mm; no less than 1.88 mm; or no less than 2.00 mm. In some implementations, oxygen carrier particles or inert particles may have D_{V}90 sizes no greater than 2.00 mm; no greater than 1.88 mm; no greater than 1.75 mm; no greater than 1.63 mm; no greater than 1.50 mm; no greater than 1.38 mm; no greater than 1.25 mm; no greater than 1.13 mm; or no greater than 1.00 mm.

Exemplary inert particles are not reactants in either reduction or oxidation reactions. Exemplary inert particles may include SiO₂, Al₂O₃, aluminosilicates, kaolin, mullite, alumina-zirconia-silica, CaAl₂O₄, CaAl₄O₇, or combinations thereof.

### B. Exemplary Input Streams

Exemplary reactors described herein may be configured to receive various input streams. The selection of input streams may depend on factors such as reaction requirements and overall process conditions. Exemplary input streams comprise fuel streams, steam (H₂O) streams, oxidation streams, and barrier streams.

Exemplary fuel streams may comprise a solid carbonaceous fuel. In some implementations, solid carbonaceous fuel may comprise biomass, plastics, coal, municipal solid waste, or combinations thereof.

Exemplary fuel streams may comprise carbonaceous volatiles. Exemplary carbonaceous volatiles comprise carbonaceous molecules in a gaseous or liquid aerosol state at the temperatures of the pyrolyzing region of the moving bed reducer reactor.

Exemplary steam (H₂O) streams comprise steam (H₂O). Exemplary steam (H₂O) streams may oxidize carbonaceous material to form carbon monoxide (CO) and hydrogen (H₂) and may oxidize oxygen carrier particles.

As used herein, the term “oxidizing stream” refers to any gaseous species capable of donating or supplying oxygen to a material, thereby increasing its oxidation state. Exemplary oxidation streams may oxidize oxygen carrier particles. Exemplary oxidation streams may also fluidize oxygen carrier particles. Exemplary oxidation streams may comprise air or steam (H₂O). Air may comprise nitrogen (N₂), oxygen (O₂), and argon (Ar).

Exemplary barrier streams comprise inert gas. As used herein, the term “inert gas” refers to any gaseous species that does not participate in oxidation or reduction reactions under process conditions. Exemplary inert gas may comprise nitrogen (N₂), argon (Ar), neon (Ne), helium (He), or combinations thereof. In some instances, exemplary inert gas may comprise nitrogen (N₂).

### C. Exemplary Output Streams

Exemplary output streams disclosed herein include pyrolyzing region output streams, gasifying region output streams, and combustor reactor output streams.

Exemplary pyrolyzing region output streams comprise carbonaceous volatiles. Carbonaceous volatiles are described above. In some instances, carbonaceous volatiles may be condensed to bio-oil.

Exemplary gasifying region output streams comprise carbon monoxide (CO) and hydrogen (H₂).

Exemplary combustor reactor output streams may comprise oxygen-depleted air, carbon monoxide (CO) and hydrogen (H₂), or air and char. Air is described above. In some instances, char includes biochar. Oxygen-depleted air comprises air depleted of oxygen (O₂).

In some instances, oxygen-depleted air may comprise between 0% oxygen (O₂) and 5% oxygen (O₂) by volume. In various implementations, oxygen-depleted air may comprise oxygen (O₂) having a vol % between 0.0% and 5.0%; 0.4% and 5.0%; 0.8% and 5.0%; 1.3% and 5.0%; 1.7% and 5.0%; 2.1% and 5.0%; 2.5% and 5.0%; 2.9% and 5.0%; 3.3% and 5.0%; 3.8% and 5.0%; 4.2% and 5.0%; 4.6% and 5.0%; 0.0% and 4.6%; 0.0% and 4.2%; 0.0% and 3.8%; 0.0% and 3.3%; 0.0% and 2.9%; 0.0% and 2.5%; 0.0% and 2.1%; 0.0% and 1.7%; 0.0% and 1.3%; 0.0% and 0.8%; or 0.0% and 0.4%. In various implementations, oxygen-depleted air may comprise oxygen (O₂) having a vol % no less than 0.0%; no less than 0.4%; no less than 0.8%; no less than 1.3%; no less than 1.7%; no less than 2.1%; no less than 2.5%; no less than 2.9%; no less than 3.3%; no less than 3.8%; no less than 4.2%; no less than 4.6%; or no less than 5.0%. In various implementations, oxygen-depleted air may comprise oxygen (O₂) having a vol % no greater than 5.0%; no greater than 4.6%; no greater than 4.2%; no greater than 3.8%; no greater than 3.3%; no greater than 2.9%; no greater than 2.5%; no greater than 2.1%; no greater than 1.7%; no greater than 1.3%; no greater than 0.8%; no greater than 0.4%; or no greater than 0.0%.

Broadly, bio-oil comprises a range of compositions related to the specific solid carbonaceous fuel pyrolyzed and the specific pyrolysis conditions used. Exemplary bio-oil comprises a mixture of non-volatile organic compounds. Exemplary bio-oil may comprise a viscous liquid comprising numerous oxygenated organic compounds and water, wherein oxygenated organic compounds comprise aldehydes, ketones, esters, carboxylic acids, phenols, furans, and/or sugars. In some instances, bio-oil may be acidic.

### III. Exemplary Systems

Various systems for processing solid carbonaceous fuel and generating carbonaceous volatiles and syngas may be used to perform exemplary methods and techniques described herein. Various aspects of exemplary reactor systems are described below.

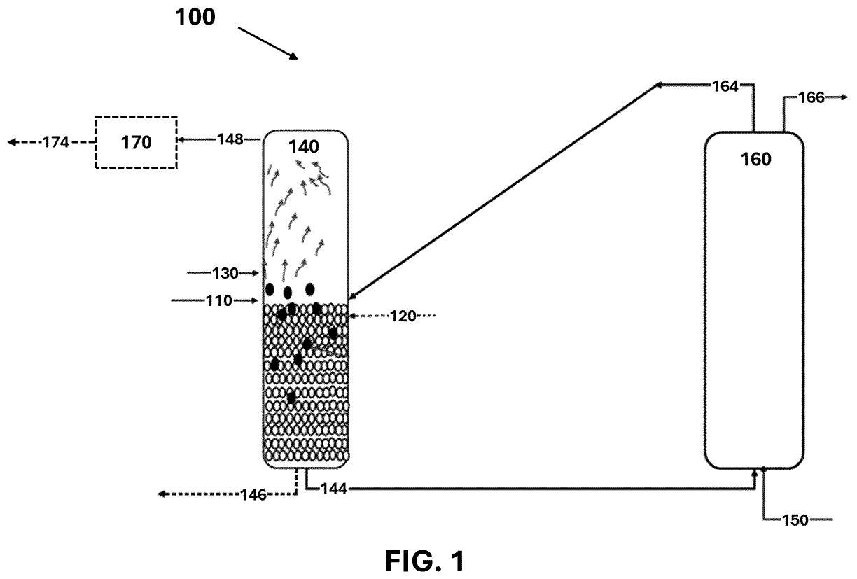

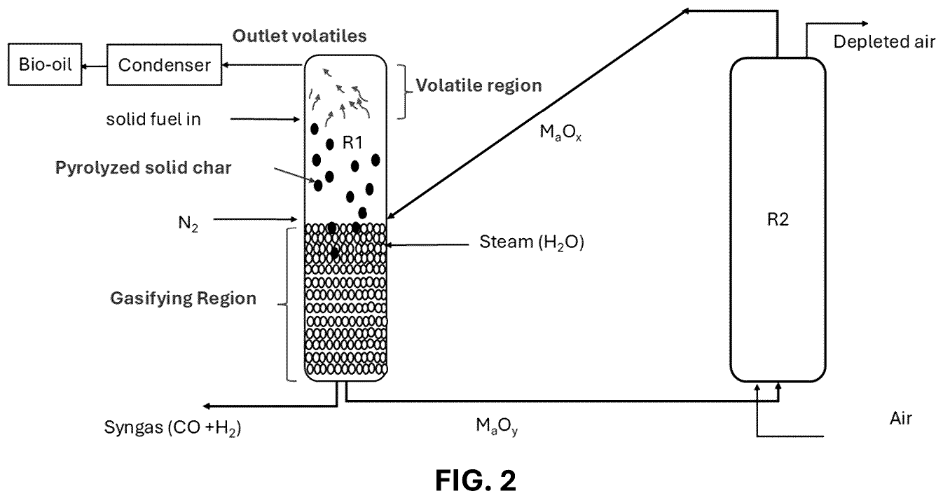

FIG. 1 schematically depicts an exemplary reactor system 100, with optional components and streams shown in dashed lines. System 100 may be particularly suited for processing solid carbonaceous fuel and generating carbonaceous volatiles and syngas, (carbon monoxide (CO) and hydrogen (H₂)). As shown, exemplary system 100 comprises a barrier stream input 110, an optional steam (H₂O) stream input 120, a fuel stream input 130, a moving bed reducer reactor 140, a moving bed reactor output 144, an optional gasifying region stream output 146, a pyrolyzing region stream output 148, a combustor oxidation stream input 150, a fluidized bed combustor reactor 160, a fluidized bed combustor reactor output 164, a combustor reactor output stream 166, an optional condenser 170 (see, for example, FIGS. 2 and 4-8), and an optional condenser output 174. Other embodiments may include more or fewer components.

Exemplary moving bed reducer reactor 140 is configured to perform various reactions, such as pyrolyzing solid carbonaceous fuel to generate carbonaceous volatiles. In some instances, exemplary moving bed reducer reactor 140 generates hydrogen (H₂) and carbon monoxide (CO) in the gasifying region, which may be provided through gasifying region stream output 146. In some instances, moving bed reducer reactor 140 may comprise a gasifying region stream output 146 as shown in FIGS. 2-5. Moving bed reducer reactor 140 is in fluid communication with fluidized bed combustor reactor 160.

Moving bed reducer reactor 140 comprises a pyrolyzing region in an upper portion of moving bed reducer reactor 140 and a gasifying region in a lower portion of the moving bed reducer reactor 140. The gasifying region may occupy between 40 volume percent (vol %) and 60 vol % of an inner volume of the moving bed reducer reactor. In various implementations, the gasifying region may occupy 40 vol % to 60 vol %; 42 vol % to 58 vol %; 45 vol % to 55 vol %; 48 vol % to 52 vol %; 40 vol % to 50 vol %; 45 vol % to 60 vol %; or 50 vol % to 60 vol % of the inner volume of the moving bed reducer reactor. In some instances, the gasifying region may occupy no greater than 60 vol %; no greater than 58 vol %; no greater than 55 vol %; no greater than 52 vol %; or no greater than 50 vol % of the inner volume of the moving bed reducer reactor. In some instances, the gasifying region may occupy no less than 40 vol %; no less than 42 vol %; no less than 45 vol %; no less than 48 vol %; or no less than 50 vol % of the inner volume of the moving bed reducer reactor.

Moving bed reducer reactor 140 is configured to receive fuel stream input 130 in the pyrolyzing region. Fuel stream input 130 may be positioned at various locations in the pyrolyzing region, provided the fuel stream input 130 is positioned above barrier stream input 110. For example, in some instances, fuel stream input 130 is positioned below a midpoint of the pyrolyzing region. For example, in some instances, fuel stream input 130 is positioned above a midpoint of the pyrolyzing region. Typically, the fuel stream input 130 is positioned not higher than the upper 50% of the pyrolyzing region.

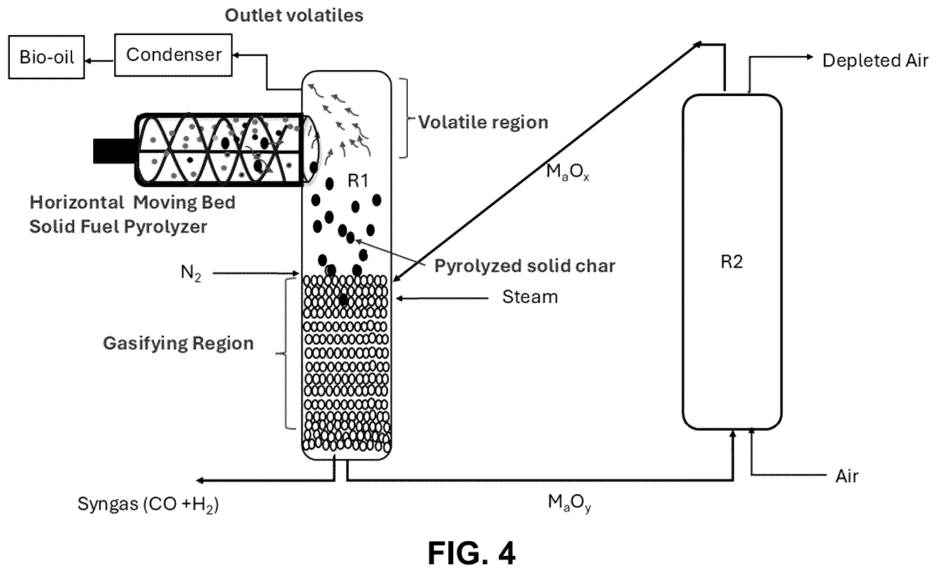

Fuel stream input 130 may be arranged to receive a solid carbonaceous fuel from a solid carbonaceous fuel stream input source. In some instances, moving bed reducer reactor 140 is configured to receive fuel stream input 130 such that fuel stream input 130 is provided by a horizontal moving bed solid fuel pyrolyzer having an auger/screw as a feeding mechanism, as shown in FIG. 4.

Moving bed reducer reactor 140 is configured to receive barrier stream input 110 adjacent to an interfacial region of the pyrolyzing region and the gasifying region. That is, the pyrolyzing region may be above barrier stream 110, and the gasifying region may be below barrier stream 110. The barrier stream input is in fluid communication with an inert gas source (not shown). The barrier stream reduces the residence time of the volatiles, which enhances the bio-oil yield. The barrier stream also acts as a gas sealant to prevent the gases formed in the bottom section of the reducer from mixing with the pyrolyzed volatiles.

In various implementations, moving bed reducer reactor 140 comprises oxygen carrier particles or inert particles. Moving bed reducer reactor 140 comprises a particle inlet configured to receive oxygen carrier particles or inert particles from fluidized bed combustor reactor 160. The moving bed reducer reactor 140 particle inlet is positioned such that the particles are provided to the gasifying region, near a middle of the moving bed reducer reactor 140. In some instances, the moving bed reducer reactor 140 particle inlet is positioned to minimize or prevent the particles from flowing through the pyrolyzing region.

Moving bed reducer reactor 140 comprises a particle outlet configured to provide a particle output stream 144. In implementations where the particles are oxygen carrier particles, the particle output stream 144 comprises reduced oxygen carrier particles, which are then regenerated in fluidized bed combustor reactor 160. The particle outlet is positioned at or near a bottom portion of moving bed reducer reactor 140. Various conveying means known in the art may be used to convey particles from moving bed reducer reactor 140 to fluidized bed combustor reactor 160.

Moving bed reducer reactor 140 comprises a pyrolyzing region outlet configured to provide a pyrolyzing region output stream 148 comprising carbonaceous volatiles. In some instances, system 100 comprises a condenser 170. Condenser 170 includes a condenser inlet configured to receive a pyrolyzing region output stream from the moving bed reducer reactor, and a condenser outlet configured to provide bio-oil.

Moving bed reducer reactor 140 is configured to receive steam (H₂O) stream input 120. Steam input 120 is positioned to provide steam to the gasifying region of moving bed reducer reactor 140. In various implementations, steam input 120 is positioned between a midpoint of the gasifying region and an upper portion of the gasifying region.

Exemplary fluidized bed combustor reactor 160 is configured to perform various reactions, such as regenerating oxygen carrier particles or oxidizing carbonaceous material deposited on inert particles. Fluidized bed combustor reactor 160 comprises oxygen carrier particles or inert particles received from moving bed reducer reactor 140.

Fluidized bed combustor reactor 160 comprises a combustor oxidation stream input 150 in fluid communication with a combustor oxidation stream input source. Additional details regarding exemplary fluidized bed combustor reactor input streams are provided above. Fluidized bed combustor reactor 160 also comprises a combustor reactor outlet 166 configured to provide a combustor reactor output stream.

Additional details regarding exemplary fluidized bed combustor reactor output streams are provided above.

In some instances, fluidized bed combustor reactor 160 comprises a combustor oxidation stream input in fluid communication with a steam (H₂O) source. In those implementations, a combustor reactor output stream may comprise carbon monoxide (CO) and hydrogen (H₂).

A fluidized bed combustor reactor output 164 discharges particles from the fluidized bed combustor reactor 160. Various apparatus and/or conveying means known in the art may be used to convey the particles from the fluidized bed combustor reactor 160 back to the moving bed reducer reactor 140.

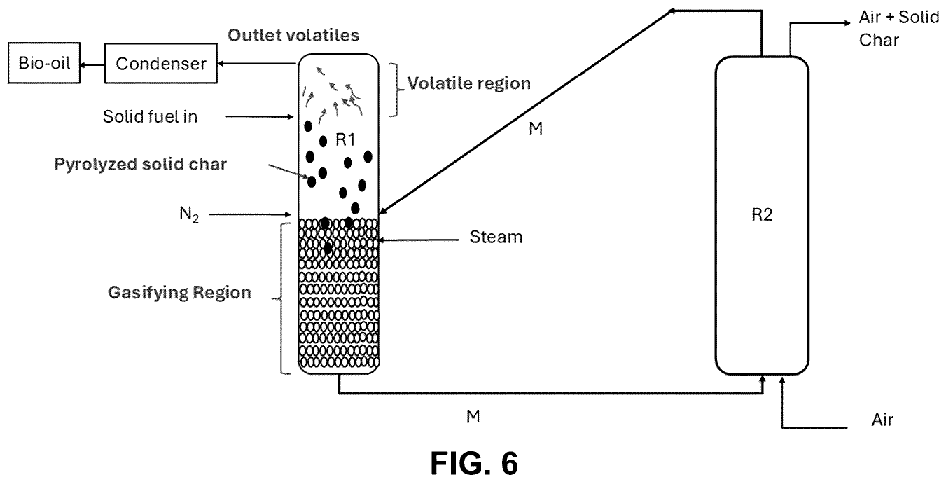

FIG. 2-8 schematically depict exemplary operational configurations of implementing reactor system 100. FIGS. 2-5 schematically depict exemplary operational configurations using oxygen carrier particles. As shown, the metal oxide particles are referred to as MₐOₓ or MₐO_{y}, where Mₐ, a=1,2,3 . . . N, where M₁ refers to single metallic oxide, M₂ refers to bi-metallic oxides, and M₃ refers to tri-metallic oxides, etc. FIGS. 6-8 schematically depict exemplary operational configurations using inert particles. The inert material used in FIGS. 6-8 is referred to as M. Details regarding exemplary reactor input and output streams are provided above.

FIG. 2 schematically depicts an exemplary operational configuration of reactor system 100. As shown, a moving bed reducer reactor comprises oxygen carrier particles and provides a gasifying region stream output to a condenser. Reduced, or partially reduced, oxygen carrier particles (MₐO_{y}) are provided from the moving bed reducer reactor to a fluidized bed combustor reactor (R2). Oxidized oxygen carrier particles (MₐOₓ) are provided from the fluidized bed combustor reactor (R2) to the gasifying region of the moving bed reducer reactor.

As shown, a fuel stream is provided to the pyrolyzing region of the moving bed reducer reactor, and a barrier stream is provided adjacent to an interface of the pyrolyzing region and the gasifying region of the reducer reactor. As shown, the exemplary barrier stream comprises nitrogen (N₂). The exemplary operational configuration of FIG. 2 also includes a condenser condensing carbonaceous volatiles into bio-oil.

The exemplary operational configuration of FIG. 2 shows that pyrolyzed carbonaceous fuel in the pyrolyzing region of the moving bed reducer reactor comprises carbonaceous volatiles and char. The carbonaceous volatiles rise to the top of the pyrolyzing region, while the char drops to the gasifying region, which comprises oxygen carrier particles.

Additionally, a steam (H₂O) stream is provided to the gasifying region to facilitate gasification. Gasification of char generates a gasifying region stream output, while the resulting reduced oxygen carrier particles are provided to the fluidized bed combustor reactor via moving bed reactor output. In the fluidized bed combustor reactor, oxygen carrier particles are oxidized by the combustor oxidation stream input to generate a combustor reactor output stream and provide oxidized oxygen particles to the moving bed reducer reactor via another combustor reactor output stream.

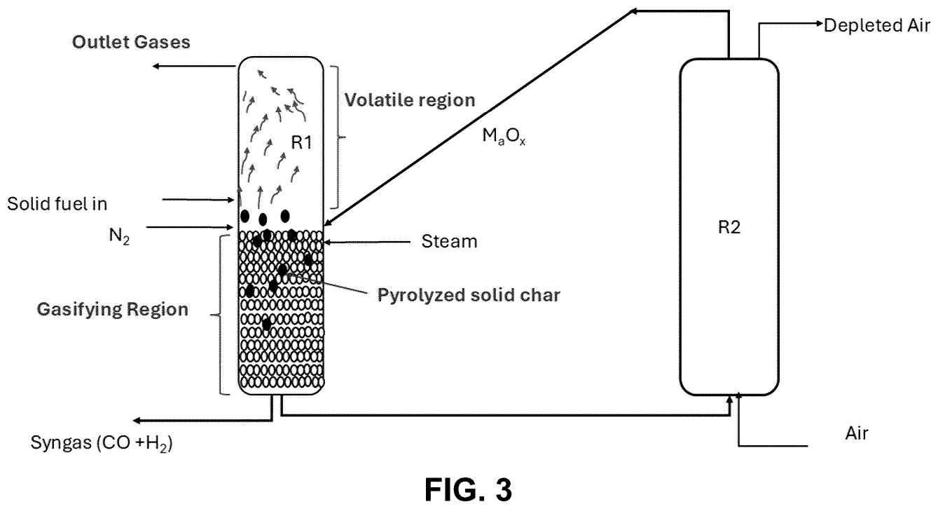

FIG. 3 schematically depicts an exemplary operational configuration of reactor system 100. As shown, oxygen carrier particles are looped between the moving bed reducer reactor and the fluidized bed combustor reactor (R2). The exemplary operational configuration of FIG. 3 parallels the operational configuration represented in FIG. 2, except the gasifying region stream output is not provided to a condenser.

FIG. 4 schematically depicts an exemplary operational configuration of reactor system 100. As shown, oxygen carrier particles are looped between the moving bed reducer reactor and the fluidized bed combustor reactor (R2). As shown, the system includes a condenser and condenser output. The exemplary operational configuration of FIG. 4 parallels the operational configuration represented in FIG. 2, but with the addition of a horizontal moving bed solid carbonaceous fuel pyrolyzer providing a fuel stream to the moving bed reducer reactor.

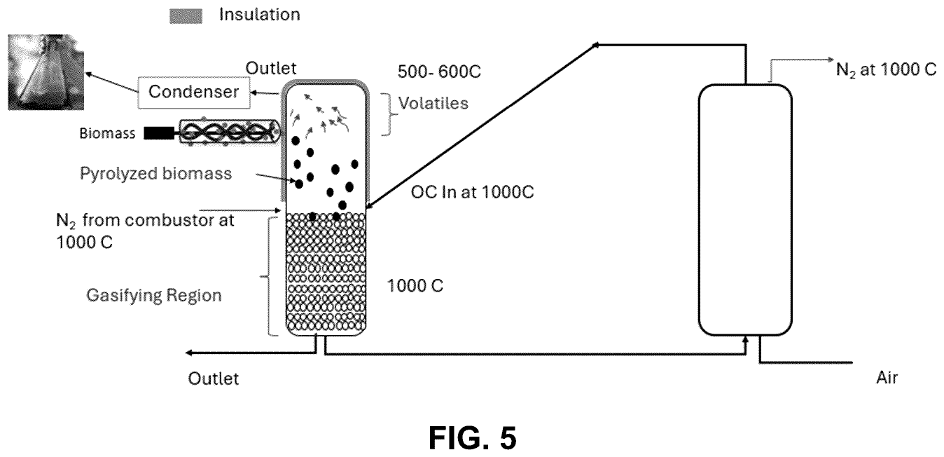

FIG. 5 schematically depicts an exemplary operational configuration of reactor system 100. As shown, oxygen carrier particles are looped between the moving bed reducer reactor and the fluidized bed combustor reactor (R2). The exemplary operational configuration of FIG. 5 parallels the operational configuration represented in FIG. 4, but with the addition of insulation surrounding the pyrolyzing portion of the moving bed reducer reactor.

The exemplary operational configuration of FIG. 5 shows that the pyrolyzing region of the moving bed reducer reactor may be operated at temperatures between 500° C. and 600° C., while the gasifying region may be operated at a temperature of approximately 1000° C. Other operational temperatures are contemplated and discussed in greater detail below.

FIG. 6 schematically depicts an exemplary operational configuration of reactor system 100. As shown, inert particles (M) are looped between the moving bed reducer reactor and the fluidized bed combustor reactor (R2).

Similar to the exemplary operational configuration of FIG. 2, in the exemplary operational configuration of FIG. 6, a fuel stream is provided to the pyrolyzing region of the moving bed reducer reactor, and a barrier stream is provided adjacent to an interface of the pyrolyzing region and the gasifying region of the reducer reactor. As shown, the exemplary barrier stream comprises nitrogen (N₂).

Exemplary operational configuration of FIG. 6 comprises pyrolyzed carbonaceous fuel in the pyrolyzing region of the moving bed reducer reactor, which comprises carbonaceous volatiles and char. The carbonaceous volatiles rise to the top of the pyrolyzing region, while the char drops to the gasifying region, below the barrier stream. Additionally, a steam (H₂O) stream is provided to the gasifying region to facilitate gasification of char. The inert particles comprising carbonaceous material are provided to the fluidized bed combustor reactor via the moving bed reactor output.

In the exemplary operational configuration of FIG. 6, carbonaceous material of the inert particles in the fluidized bed combustor reactor is removed owing to turbulent conditions maintained in the fluidized bed combustor reactor by combustor oxidation stream input, which generates a combustor reactor output stream as well as provides inert particles to the moving bed reducer reactor via combustor reactor output streams.

In the exemplary operational configuration of FIG. 6, the combustor reactor output stream comprises air and char.

Further, the exemplary operational configuration of FIG. 6 shows a condenser condensing carbonaceous volatiles into bio-oil.

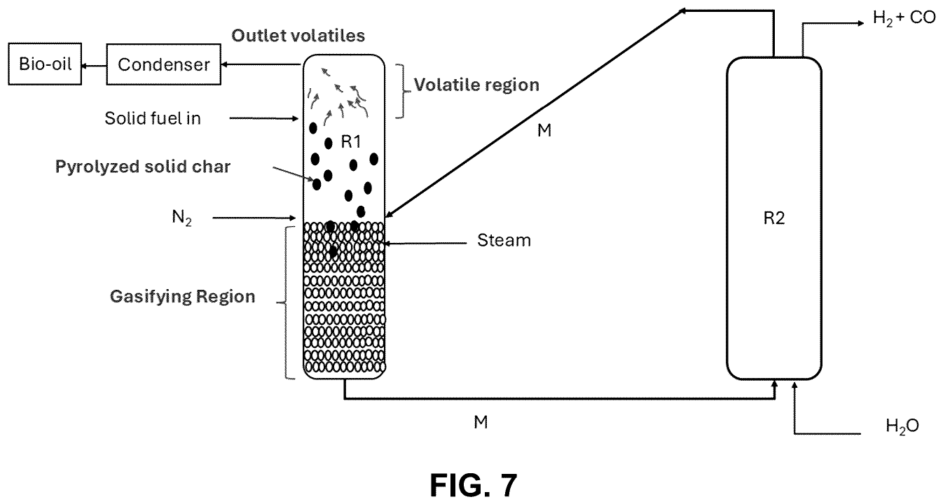

FIG. 7 schematically depicts an exemplary operational configuration of reactor system 100. As shown, inert particles (M) are looped between the moving bed reducer reactor and the fluidized bed combustor reactor (R2). The exemplary operational configuration of FIG. 7 parallels the operational configuration represented in FIG. 6, but with the combustor oxidation stream input comprising steam (H₂O) as opposed to air, and the combustor reactor output stream comprising carbon monoxide (CO) and hydrogen (H₂) as opposed to air and char.

In the exemplary operational configuration of FIG. 7, steam (H₂O) of the combustor oxidation stream input oxidizes carbonaceous material deposited on inert particles to generate carbon monoxide (CO) and hydrogen (H₂) of the combustor reactor output stream.

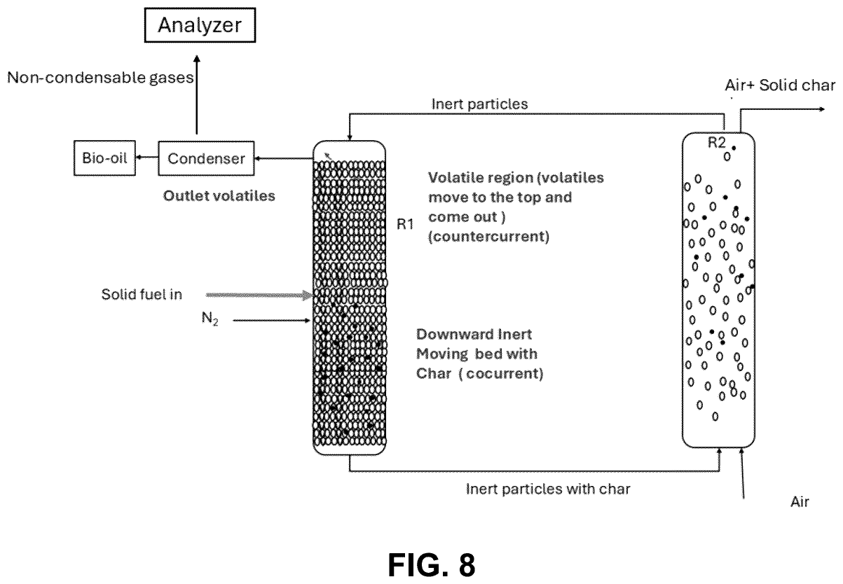

FIG. 8 schematically depicts an exemplary operational configuration of a reactor system where the moving bed reducer reactor comprises inert particles. As shown, inert particles (M) are looped between the moving bed reducer reactor and the fluidized bed combustor reactor (R2). The system shown in FIG. 8 also includes a condenser and an analyzer.

The exemplary operational configuration of FIG. 8 parallels the system shown in FIG. 6, but the inert particles are provided at, or near a top of the reducer reactor. Thus, the inert particles flow through both the pyrolyzing region and the gasifying region. Inert particles occupy at least 90 volume percent (vol %) of the inner volume of the moving bed reducer reactor, as the inert particles move downward through the moving bed reducer reactor. In some implementations, inert particles occupy 90 vol % to 98 vol % of the inner volume as the inert particles move through the moving bed reducer reactor.

Additionally, as shown, non-condensable gases are provided as an output from the condenser unit. Those non-condensable gases may be provided to an analyzer unit.

### IV. Exemplary Methods

Various methods may be employed to operate exemplary reactor systems contemplated herein. Exemplary reactor systems and materials described above may be used to implement one or more of the methods described below. Other embodiments may include more or fewer operations than those discussed below.

Operating a reactor system may include providing a fuel stream to a pyrolyzing region of the reducer reactor, the fuel stream comprising solid carbonaceous fuel. The gasifying region is positioned in a lower portion of the reducer reactor, and the pyrolyzing region is positioned in an upper portion of the reducer reactor.

In some implementations, the pyrolyzing region may be operated at a temperature between 400° C. and 700° C.; 425° C. and 700° C.; 450° C. and 700° C.; 475° C. and 700° C.; 500° C. and 700° C.; 525° C. and 700° C.; 550° C. and 700° C.; 575° C. and 700° C.; 600° C. and 700° C.; 625° C. and 700° C.; 650° C. and 700° C.; 675° C. and 700° C.; 400° C. and 675° C.; 400° C. and 650° C.; 400° C. and 625° C.; 400° C. and 600° C.; 400° C. and 575° C.; 400° C. and 550° C.; 400° C. and 525° C.; 400° C. and 500° C.; 400° C. and 475° C.; 400° C. and 450° C.; or 400° C. and 425° C. In some implementations, the pyrolyzing region may be operated at a temperature no less than 400° C.; no less than 425° C.; no less than 450° C.; no less than 475° C.; no less than 500° C.; no less than 525° C.; no less than 550° C.; no less than 575° C.; no less than 600° C.; no less than 625° C.; no less than 650° C.; no less than 675° C.; or no less than 700° C. In some implementations, the pyrolyzing region may be operated at a temperature no greater than 700° C.; no greater than 675° C.; no greater than 650° C.; no greater than 625° C.; no greater than 600° C.; no greater than 575° C.; no greater than 550° C.; no greater than 525° C.; no greater than 500° C.; no greater than 475° C.; no greater than 450° C.; no greater than 425° C.; or no greater than 400° C.

In some implementations, the gasifying region may be operated at a temperature between 900° C. and 1100° C.; 925° C. and 1100° C.; 950° C. and 1100° C.; 975° C. and 1100° C.; 1000° C. and 1100° C.; 1025° C. and 1100° C.; 1050° C. and 1100° C.; 1075° C. and 1100° C.; 900° C. and 1075° C.; 900° C. and 1050° C.; 900° C. and 1025° C.; 900° C. and 1000° C.; 900° C. and 975° C.; 900° C. and 950° C.; or 900° C. and 925° C. In some implementations, the gasifying region may be operated at a temperature no less than 900° C.; no less than 925° C.; no less than 950° C.; no less than 975° C.; no less than 1000° C.; no less than 1025° C.; no less than 1050° C.; no less than 1075° C.; or no less than 1100° C. In some implementations, the gasifying region may be operated at a temperature no greater than 1100° C.; no greater than 1075° C.; no greater than 1050° C.; no greater than 1025° C.; no greater than 1000° C.; no greater than 975° C.; no greater than 950° C.; no greater than 925° C.; or no greater than 900° C.

In some implementations, providing a fuel stream to a pyrolyzing region of the reducer reactor may occur such that a residence time in the pyrolyzing region is between 10 seconds and 90 seconds. Exemplary methods may include providing solid carbonaceous fuel in the pyrolyzing region of the moving bed reducer reactor. Solid carbonaceous fuel may be provided such that the residence time is 10 seconds to 90 seconds in the pyrolyzing region of the moving bed reducer reactor. In various implementations, the residence time of solid carbonaceous fuel in the pyrolyzing region of the moving bed reducer reactor may have a time between 10 s and 90 s; 20 s and 90 s; 30 s and 90 s; 40 s and 90 s; 50 s and 90 s; 60 s and 90 s; 70 s and 90 s; 80 s and 90 s; 10 s and 80 s; 10 s and 70 s; 10 s and 60 s; 10 s and 50 s; 10 s and 40 s; 10 s and 30 s; or 10 s and 20 s. In various implementations, the residence time of solid carbonaceous fuel in the pyrolyzing region of the moving bed reducer reactor may have a time in seconds no less than 10 s; no less than 20 s; no less than 30 s; no less than 40 s; no less than 50 s; no less than 60 s; no less than 70 s; no less than 80 s; or no less than 90 s. In various implementations, the residence time of solid carbonaceous fuel in the pyrolyzing region of the moving bed reducer reactor may have a time in seconds no greater than 90 s; no greater than 80 s; no greater than 70 s; no greater than 60 s; no greater than 50 s; no greater than 40 s; no greater than 30 s; no greater than 20 s; or no greater than 10 s.

Exemplary methods may include providing particles to a gasifying region of the moving bed reducer reactor. The particles may be provided near a midpoint of the moving bed reducer reactor. In some instances, the particles are provided such that the particles do not flow through the pyrolyzing region of the moving bed reducer reactor.

In some alternative implementations involving inert particles, exemplary methods may include providing inert particles to a top portion of the reducer reactor, such that the particles flow downward through both the pyrolyzing region and the gasifying region.

Exemplary methods may include providing a barrier stream adjacent to an interface of the pyrolyzing region and the gasifying region of the reducer reactor. The barrier stream comprises an inert gas, and additional details are discussed above. The gasifying region of the reducer reactor may comprise oxygen carrier particles.

A steam (H₂O) stream may be provided to the gasifying region of the reducer reactor, such that the steam (H₂O) stream contacts the oxygen carrier particles, oxidizing carbonaceous material on the oxygen carrier particles and oxidizing the oxygen carrier particles.

Example methods include collecting a pyrolyzing region output stream generated in the reducer reactor from a pyrolyzing region outlet, where the pyrolyzing region output stream comprises carbonaceous volatiles. Example methods also include collecting a gasifying region output stream generated in the reducer reactor from a gasifying region outlet, where the gasifying region output stream may comprise carbon monoxide (CO) and hydrogen (H₂).

In some implementations, the pyrolyzing region output stream may be provided to a condenser, condensing carbonaceous volatiles to bio-oil.

In some implementations, the fuel stream may comprise solid carbonaceous fuel and carbonaceous volatiles from a moving bed solid fuel pyrolyzer.

In some implementations, partially reduced oxygen carrier particles may be provided to the combustor reactor. An oxidation stream may be provided to the combustor reactor such that the oxidation stream contacts the oxygen carrier particles, oxidizing the oxygen carrier particles, and fluidizing the oxygen carrier particles. Various oxidation streams are discussed above, and in some instances, may comprise air.

In some implementations, the fluidized bed combustor reactor may be operated at a temperature between 900° C. and 1100° C.; 925° C. and 1100° C.; 950° C. and 1100° C.; 975° C. and 1100° C.; 1000° C. and 1100° C.; 1025° C. and 1100° C.; 1050° C. and 1100° C.; 1075° C. and 1100° C.; 900° C. and 1075° C.; 900° C. and 1050° C.; 900° C. and 1025° C.; 900° C. and 1000° C.; 900° C. and 975° C.; 900° C. and 950° C.; or 900° C. and 925° C. In some implementations, the fluidized bed combustor reactor may be operated at a temperature no less than 900° C.; no less than 925° C.; no less than 950° C.; no less than 975° C.; no less than 1000° C.; no less than 1025° C.; no less than 1050° C.; no less than 1075° C.; or no less than 1100° C. In some implementations, the fluidized bed combustor reactor may be operated at a temperature no greater than 1100° C.; no greater than 1075° C.; no greater than 1050° C.; no greater than 1025° C.; no greater than 1000° C.; no greater than 975° C.; no greater than 950° C.; no greater than 925° C.; or no greater than 900° C.

In some implementations, a combustor reactor output stream may be collected from a combustor reactor outlet. Typically, the combustor reactor output stream comprises oxygen-depleted air.

In some instances, such as that shown in FIG. 5, the combustor reactor output stream may be provided as a barrier stream to the moving bed reducer reactor.

In some implementations, exemplary methods may include providing inert particles to the gasifying region of the reducer reactor. A steam (H₂O) stream may be provided to the gasifying region of the reducer reactor, such that the steam (H₂O) stream contacts the carbonaceous material on the inert particles and the carbonaceous material is oxidized.

In some instances, example methods may include providing inert particles to the combustor reactor. An oxidation stream may be provided to the combustor reactor, such that the oxidation stream contacts carbonaceous material on the inert particles and the carbonaceous material is oxidized. The oxidation stream provided to the combustor reactor may be provided at flow rates to fluidize the inert particles.

In various implementations, the oxidation stream may comprise air, and the combustor reactor output stream may comprise air and char. Alternatively, the oxidation stream may comprise steam (H₂O), and the combustor reactor output stream may comprise carbon monoxide (CO) and hydrogen (H₂). Exemplary methods may include collecting a gasifying region output stream generated in the reducer reactor from a gasifying region outlet, where the gasifying region output stream comprises carbon monoxide (CO) and hydrogen (H₂).

After the particles pass through the fluidized bed combustor reactor, exemplary methods include providing the particles back to the moving bed reducer reactor. Various apparatus and/or conveying means known in the art may be used to convey the particles from the fluidized bed combustor reactor back to the moving bed reducer reactor. Heat generated in the combustor reactor provides heat to the pyrolyzing region via the particles.

### V. Experimental Data

Exemplary experimental examples were generated, and the results are discussed below.

Biomass comprising crushed southern yellow pine with a size of 500 to 1000 μm was continuously injected into a moving bed reducer reactor using a horizontal auger/screw at a biomass flow rate of 1 g/min. Experiments were conducted at reactor temperatures of 400° C., 500° C., and 600° C. The entire reactor was filled with inert particles, which were alumina beads. The flow rate of the alumina beads was 25 g/min. The biomass was pyrolyzed in the middle of the reactor as soon as it entered. Carbonaceous volatiles moved to the top of the reactor, and char moved to the bottom of the reactor. Gas outputs were drawn from a top outlet of the moving bed reducer reactor and analyzed for CO₂, CO, CH₄, and H₂ concentrations.

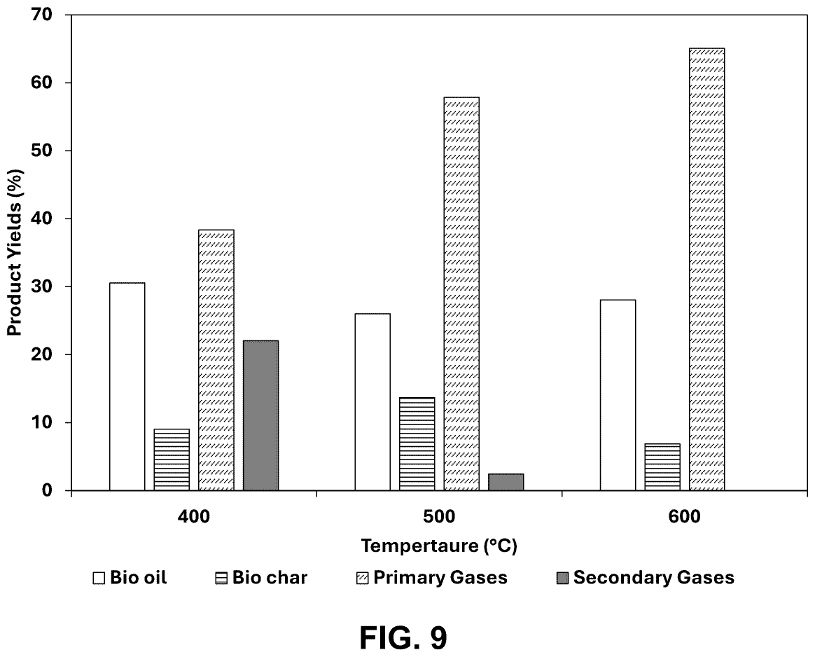

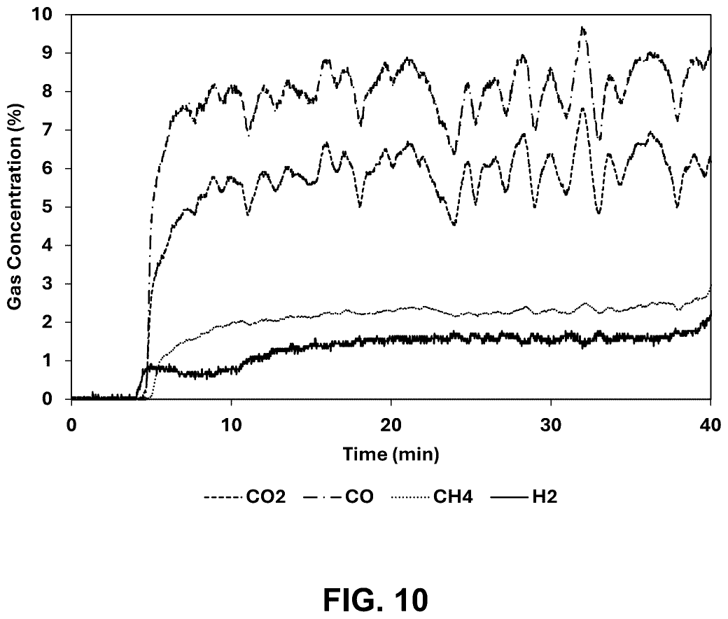

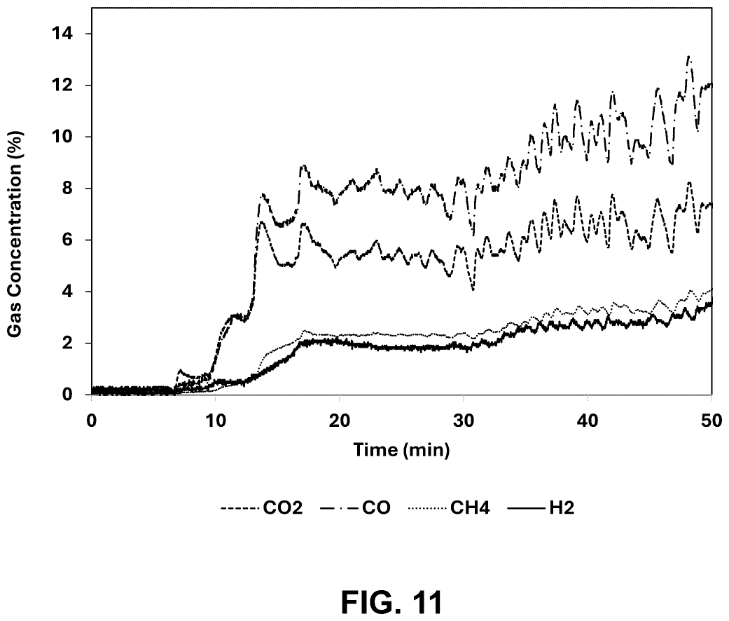

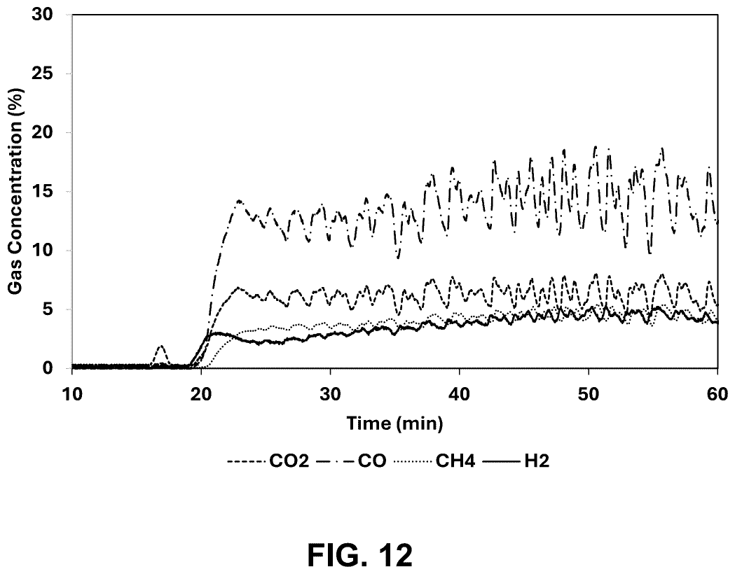

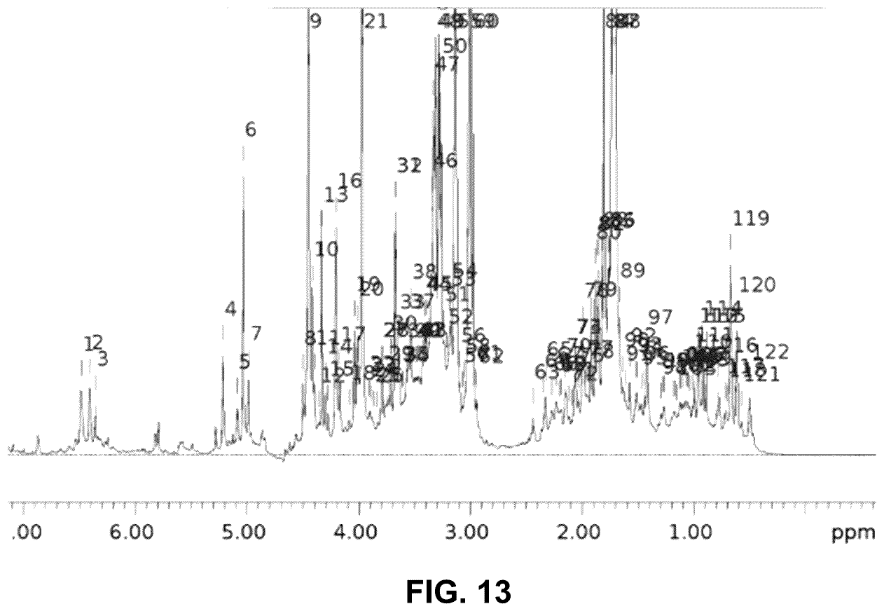

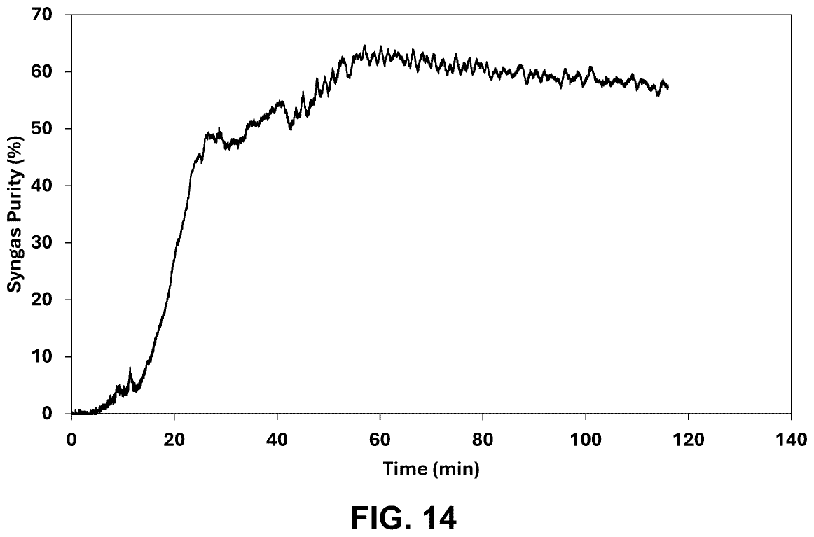

FIGS. 9-14 show the experimental results regarding bio-oil, biochar, and gas yields. FIG. 9 is a bar graph showing product yield for three different moving bed reducer reactor temperatures of 400° C., 500° C., and 600° C. FIG. 10 is a plot showing gas concentration as a function of time, with a moving bed reducer reactor temperature of 400° C. FIG. 11 is a plot showing gas concentration as a function of time, with a moving bed reducer reactor temperature of 500° C. FIG. 12 is a plot showing gas concentration as a function of time, with a moving bed reducer reactor temperature of 600° C. FIG. 13 is a 1H NMR spectrum of exemplary bio-oil produced with a moving bed reducer reactor temperature of 500° C. FIG. 14 is a plot showing syngas purity as a function of time, with a moving bed reducer reactor temperature of 500° C.

Exemplary bio-oil was analyzed by ¹H NMR from 0 ppm to 7 ppm and compared to a reference ¹H NMR from N. Hao, H. Ben, C. G. Yoo, S. Adhikari, and A. J. Ragauskas, “Review of NMR Characterization of Pyrolysis Oils,” Energy Fuels, 2016, 30(9), 6863-6880. DMSO was used as the solvent and 850 MHZ NMR was used.

1. A method for operating a reactor system comprising a reducer reactor and a combustor reactor, the method comprising:
providing a fuel stream to a pyrolyzing region of the reducer reactor,
the fuel stream comprising solid carbonaceous fuel;
wherein the gasifying region is in a lower portion of the reducer reactor and the pyrolyzing region is in an upper portion of the reducer reactor;
providing a barrier stream adjacent to an interface of the pyrolyzing region and the gasifying region of the reducer reactor, the barrier stream comprising an inert gas;
providing oxygen carrier particles to the gasifying region of the reducer reactor;
providing a steam (H₂O) stream to the gasifying region of the reducer reactor, such that the steam (H₂O) stream contacts the oxygen carrier particles, oxidizing carbonaceous material on the oxygen carrier particles and oxidizing the oxygen carrier particles;
collecting a pyrolyzing region output stream generated in the reducer reactor from a pyrolyzing region outlet, the pyrolyzing region output stream comprising carbonaceous volatiles;
collecting a gasifying region output stream generated in the reducer reactor from a gasifying region outlet, the gasifying region output stream comprising carbon monoxide (CO) and hydrogen (H₂);
providing partially reduced oxygen carrier particles to the combustor reactor;
providing an oxidation stream to the combustor reactor such that the oxidation stream contacts the oxygen carrier particles, oxidizing the oxygen carrier particles, and fluidizing the oxygen carrier particles, the oxidation stream comprising air;
collecting a combustor reactor output stream from a combustor reactor outlet, the combustor reactor output stream comprising oxygen-depleted air; and
providing the oxidized oxygen carrier particles from the combustor reactor to the reducer reactor.

2. The method of claim 1, wherein the solid carbonaceous fuel comprises biomass and wherein the method further comprises:
providing a fuel stream to a pyrolyzing region of the reducer reactor such that a residence time in the pyrolyzing region is between 10 seconds and 90 seconds; and
providing the pyrolyzing region output stream to a condenser.

3. The method of claim 1, wherein the solid carbonaceous fuel comprises biomass and wherein the method further comprises:
providing a fuel stream to a pyrolyzing region of the reducer reactor, such that a residence time in the pyrolyzing region is between 10 seconds and 90 seconds.

4. The method of claim 1, wherein the fuel stream comprises solid carbonaceous fuel and carbonaceous volatiles from a moving bed solid fuel pyrolyzer, and wherein the method further comprises:
providing a fuel stream to a pyrolyzing region of the reducer reactor, such that a residence time in the pyrolyzing region is between 10 seconds and 90 seconds; and
providing the pyrolyzing region output stream to a condenser such that carbonaceous volatiles are condensed to bio-oil.

5. The method of claim 1, wherein an inert gas comprises nitrogen (N₂), argon (Ar), neon (Ne), helium (He), or combinations thereof.

6. The method of claim 1, wherein the oxygen carrier particles comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof.

7. The method of claim 1, wherein solid carbonaceous fuel comprises biomass, plastics, coal, municipal solid waste, or combinations thereof.

8. The method of claim 1, wherein oxygen-depleted air comprises air depleted of oxygen (O₂) to less than 5% by volume.

9. A reactor system, comprising:
a moving bed reducer reactor comprising:
a pyrolyzing region in an upper portion of the moving bed reducer reactor;
a gasifying region in a lower portion of the moving bed reducer reactor, the gasifying region occupying between 40 volume percent (vol %) and 60 vol % of an inner volume of the moving bed reducer reactor and comprising:
oxygen carrier particles or inert particles,
a steam (H₂O) stream input,
a particle outlet configured to provide a particle output stream; and
a barrier stream input adjacent to an interfacial region of the pyrolyzing region and the gasifying region, the barrier stream input in fluid communication with an inert gas source;
a solid carbonaceous fuel stream inlet positioned in the pyrolyzing region and configured to receive a solid carbonaceous fuel from a solid carbonaceous fuel stream input source;
a barrier stream inlet configured to receive the barrier stream input from a barrier stream input source;
a steam (H₂O) inlet configured to receive steam (H₂O) from a steam (H₂O) stream input source;
a particle inlet positioned in the gasifying region and configured to receive oxygen carrier particles or inert particles from an oxygen carrier particle or inert particle input source;
a pyrolyzing region outlet configured to provide a pyrolyzing region output stream comprising carbonaceous volatiles; and
a fluidized bed combustor reactor comprising:
oxygen carrier particles or inert particles;
a combustor oxidation stream inlet in fluid communication with a combustor oxidation stream input source configured to receive a combustor oxidation stream input; and
a combustor reactor outlet configured to provide a combustor reactor output stream.

10. The reactor system of claim 9, wherein the particles are oxygen carrier particles and wherein the reactor system further comprises:
a condenser, comprising:
a condenser inlet configured to receive a pyrolyzing region output stream from the moving bed reducer reactor; and
a condenser outlet configured to provide bio-oil;
a gasifying region outlet configured to provide a gasifying region output stream comprising carbon monoxide (CO) and hydrogen (H₂);
a combustor oxidation stream input in fluid communication with an air source; and
a combustor reactor output stream configured to provide oxygen-depleted air.

11. The reactor system of claim 9, wherein the particles are inert particles and wherein the reactor system further comprises:
a condenser, comprising:
a condenser inlet configured to receive a pyrolyzing region output stream from the moving bed reducer reactor; and
a condenser outlet configured to provide bio-oil;
a combustor oxidation stream input in fluid communication with a steam (H₂O) source; and
a combustor reactor output stream configured to provide carbon monoxide (CO) and hydrogen (H₂).

12. The reactor system of claim 9, wherein the oxygen carrier particles comprise iron oxide (Fe₂O₃), copper oxide (CuO), nickel oxide (NiO), manganese oxide (Mn₂O₃), cerium oxide (CeO₂), cobalt oxide (Co₃O₄), tungsten oxide (WO₃), vanadium oxide (V₂O₅), calcium and iron oxide (Ca₂Fe₂O₅), or combinations thereof.

13. The reactor system of claim 9, wherein the inert particles are not reactants in either reduction or oxidation reactions and include SiO₂, Al₂O₃, aluminosilicates, kaolin, mullite, alumina-zirconia-silica, CaAl₂O₄, CaAl₄O₇, or combinations thereof.

14. The reactor system of claim 9, wherein the oxygen carrier particles comprise iron oxide (Fe₂O₃) and wherein the inert particles comprise alumina (Al₂O₃).

15. A method for operating a reactor system comprising a reducer reactor and a combustor reactor, the method comprising:
providing a fuel stream to a pyrolyzing region of the reducer reactor,
the fuel stream comprising solid carbonaceous fuel,
wherein the gasifying region is in a lower portion of the reducer reactor and the pyrolyzing region is in an upper portion of the reducer reactor;
providing a barrier stream adjacent to an interface of the pyrolyzing region and the gasifying region of the reducer reactor, the barrier stream comprising an inert gas;
providing inert particles to the gasifying region of the reducer reactor;
providing a steam (H₂O) stream to the gasifying region of the reducer reactor, such that the steam (H₂O) stream contacts the carbonaceous material on the inert particles and the carbonaceous material is oxidized;
collecting a pyrolyzing region output stream generated in the reducer reactor from a pyrolyzing region outlet, the pyrolyzing region output stream comprising carbonaceous volatiles;
providing the pyrolyzing region output stream to a condenser;
providing inert particles to the combustor reactor;
providing an oxidation stream to the combustor reactor, such that the oxidation stream contacts carbonaceous material on the inert particles and the carbonaceous material is oxidized, and fluidizing the inert particles;
collecting a combustor reactor output stream from a combustor reactor outlet; and
providing the inert particles from the combustor reactor to the reducer reactor, wherein heat generated in a combustor reactor provides heat to the pyrolyzing region via the inert particles.

16. The method of claim 15, wherein the oxidation stream comprises air, and the combustor reactor output stream comprises air and char, and wherein the method further comprises:
providing a fuel stream to a pyrolyzing region of the reducer reactor, such that a residence time in the pyrolyzing region is between 10 seconds and 90 seconds.

17. The method of claim 15, wherein the oxidation stream comprises steam (H₂O), and the combustor reactor output stream comprises carbon monoxide (CO) and hydrogen (H₂), and wherein the method further comprises:
providing a fuel stream to a pyrolyzing region of the reducer reactor, such that a residence time in the pyrolyzing region is between 10 seconds and 90 seconds;
collecting a gasifying region output stream generated in the reducer reactor from a gasifying region outlet, the gasifying region output stream comprising carbon monoxide (CO) and hydrogen (H₂).

18. The method of claim 15, wherein the inert particles are not reactants in either reduction or oxidation reactions and include SiO₂, Al₂O₃, aluminosilicates, kaolin, mullite, alumina-zirconia-silica, CaAl₂O₄, or CaAl₄O₇.

19. The method of claim 15, wherein an inert gas comprises nitrogen (N₂), argon (Ar), neon (Ne), helium (He), or combinations thereof; and
wherein solid carbonaceous fuel comprises biomass, plastics, coal, municipal solid waste, or combinations thereof.

20. The method of claim 15, wherein the inert particles are provided near a top of the reducer reactor such that the inert particles flow through both the pyrolyzing region and the gasifying region.
